(19) United States
(12) Patent Application Publication
(10) Pub. No.: US 2011/0175951 A1
(43) Pub. Date: Jul. 21, 2011

(54) ILLUMINATING APPARATUS AND LIQUID CRYSTAL DISPLAY DEVICE PROVIDED THEREWITH

(75) Inventors: Hiroyuki Nabesawa, Osaka (JP); Akira Tomiyoshi, Osaka (JP)

(73) Assignee: SHARP KABUSHIKI KAISHA, Osaka-shi, Osaka (JP)

(21) Appl. No.: 13/121,436

(22) PCT Filed: Jun. 11, 2009
(86) PCT No.: PCT/JP2009/060665

§ 371 Date: Mar. 29, 2011

(30) Foreign Application Priority Data
Oct. 8, 2008 (JP) 2008-261513

(51) Int. Cl. G09G 3/36; H05B 37/02; G09G 5/10

(52) U.S. Cl. 345/690; 315/294; 345/102; 345/88

(57) ABSTRACT

Provided is an illuminating apparatus wherein a time for correcting the color of illuminating light can be shortened. The illuminating apparatus (10) is provided with a plurality of light-emitting elements (3) respectively containing a red LED (3a), a green LED (3b), and a blue LED (3c); an output section (15) outputting a value according to the brightness of received light; and a main controller (11) for color correction operation of correcting the color of the illuminating light. The main controller is so configured that the controller doesn't perform the color correction operation with respect to a light-emitting element wherein output values of one or more of the red LED, green LED, and blue LED are judged to be a predetermined value or more.

### TECHNICAL FIELD

The present invention is related to an illuminating apparatus and a liquid crystal display device provided therewith.

### BACKGROUND ART

There have conventionally been known illuminating apparatuses that use a light source formed of a red light emitting diode (a red LED) that emits red light, a green light emitting diode (a green LED) that emits green light, and a blue light emitting diode (a blue LED) that emits blue light, and such illuminating apparatuses have been used as a backlight unit for illuminating a liquid crystal display panel of a liquid crystal display device. The conventional illuminating apparatuses of such a type generate white light by mixing three kinds of LED light (red light, green light, and blue light) emitted from the LEDs, and use the white light as illuminating light (see, for example, Patent Document 1 listed below).

To obtain white light as illuminating light having a preferable color by using the above-described illuminating apparatuses, it is necessary to appropriately set the brightness ratio of the three kinds of LED light. For this purpose, a value of an operation current supplied to each of the red, green, and blue LEDs has conventionally been set such that the brightness ratio of the three kinds of LED light is an appropriate value.

However, as shown in FIG. 7, the red, green and blue LEDs deteriorate at different speeds, and the difference among the deterioration rates gradually increases with time of use. This means that a situation may arise in which one of the red, green, and blue LEDs is much more deteriorated than the other two. In FIG. 7, symbols “R”, “G” and “B” indicate the brightness of the red LED, the brightness of the green LED, and the brightness of the blue LED, respectively, based on the initial brightness of each of the LEDs as 100%.

When the difference between the deterioration rates of the red, green, and blue LEDs are large, if a current continues to be supplied to each of LEDs under the same condition as at the beginning of their use, the brightness ratio of the three kinds of LED light greatly deviates from the initial appropriate value of the brightness ratio of the three kinds of LED light. This results in an unfavorable color of the illuminating light, which is disadvantageous. Thus, to eliminate this disadvantage, the conventional illuminating apparatuses are structured to be capable of performing a color correction operation.

In the conventional illuminating apparatuses structured to perform the color correction operation as described above, for example, in the initial state of use, an initial brightness of light emitted from each of the LEDs is measured beforehand. A deterioration rate of each of the LEDs is obtained by measuring the brightness of the light emitted from each of the LEDs at the time when the color correction operation is to be performed. Then, after a correction value is calculated from the deterioration rate of each of the LEDs, a value of an operation current supplied to each of the LEDs is corrected based on the correction value to thereby restore the brightness ratio of the three kinds of LED light to its initial state. Thereby, the color of the illuminating light obtained by mixing the three kinds of LED light is corrected to its initial state.

### PRIOR ART DOCUMENT

### Patent Document

Patent Document 1: JP-A-2004-93761

### DISCLOSURE OF THE INVENTION

### Problems to be Solved by the Invention

However, the above-described conventional color correction operation, in which the brightness of light is measured with respect to each individual light emitting device, suffers from a disadvantage that the larger the number of light emitting devices is, the longer time it takes to complete the color correction operation (to correct the color of illuminating light).

The present invention has been made to solve the above problems, and an object of the present invention is to provide an illuminating apparatus capable of correcting the color of illuminating light in a shorter period of time, and a liquid crystal display device provided therewith.

### Means for Solving the Problem

To achieve the above object, according to a first aspect of the present invention, an illuminating apparatus that generates illuminating light by mixing red light, green light, and blue light, and that illuminates a target to be illuminated with the illuminating light is provided with: a plurality of light emitting devices each including a red light emitting diode that emits red light, a green light emitting diode that emits green light, and a blue light emitting diode that emits blue light; an output portion that receives light emitted from each of the red light emitting diode, the green light emitting diode, and the blue light emitting diode, and that outputs a value corresponding to brightness of received light; and a control portion that obtains a deterioration rate of each of the red light emitting diode, the green light emitting diode, and the blue light emitting diode from an output value of the output portion, and that performs a color correction operation of correcting a color of the illuminating light by adjusting, based on the deterioration rate, a value of an operation current supplied to each of the red light emitting diode, the green light emitting diode, and the blue light emitting diode. Here, the control portion performs, with respect to each of the red light emitting diode, the green light emitting diode, and the blue light emitting diode, judgment of whether or not the output value at an initial operation before the color correction operation is performed is equal to or larger than a predetermined value, the control portion performing the color correction operation to a light emitting device of the light emitting devices with respect to which the output value is judged to be smaller than the predetermined value with respect to all the red light emitting diode, the green light emitting diode, and the blue light emitting diode, and the control portion not performing the color correction operation to a light emitting device of the light emitting devices with respect to which the output value is judged to be equal to or larger than the predetermined value with respect to at least one of the red light emitting diode, the green light emitting diode, and the blue light emitting diode.

With the illuminating apparatus according to the first aspect, as described above, the control portion performs, with respect to each of the red light emitting diode, the green light emitting diode, and the blue light emitting diode, judgment of whether or not the output value at the initial operation before the color correction operation is performed is equal to or larger than the predetermined value. As the output value of a light emitting diode (a light emitting device) in response to a current supplied thereto increases (that is, as the light emitting efficiency increases), the value of a current (a value of an operation current) that is supplied to the light emitting diode in its operation decreases, and thus accordingly less heat is generated in its operation. Thus, a light emitting device the output value of which is large is less likely to deteriorate after a long time of use, compared with a light emitting device the output value of which is small. That is, a light emitting device of a large output value is less liable to deteriorate the color of the illuminating light, and this reduces the necessity of the color correction operation. Thus, even if the control portion is structured, as described above, such that it does not perform the color correction operation to a light emitting device with respect to which the output value is found to be equal to or larger than the predetermined value with respect to at least one of the red light emitting diode, the green light emitting diode, and the blue light emitting diode, it is possible to reduce deterioration of the color of the illuminating light. Moreover, since the color correction operation is performed less frequently, the length of time taken for the color correction operation can accordingly be reduced.

In the illuminating apparatus according to the above-described first aspect, it is preferable that the output portion include an AD conversion portion that converts a value based on brightness of light emitted from each of the red light emitting diode, the green light emitting diode, and the blue light emitting diode, from an analog value to a digital value and that feeds the digital value to the control portion, and that the control portion judge, with respect to each of the red light emitting diode, the green light emitting diode, and the blue light emitting diode, whether or not the digital value at the initial operation has overflowed, the control portion performing the color correction operation to a light emitting device of the light emitting devices with respect to which the digital value is judged, with respect to all the red light emitting diode, the green light emitting diode, and the blue light emitting diode, not to have overflowed, and the control portion not performing the color correction operation to a light emitting device of the light emitting devices with respect to which the digital value is judged to have overflowed with respect to at least one of the red light emitting diode, the green light emitting diode, and the blue light emitting diode. With this structure, since the color correction operation is not performed to a light emitting device with respect to which the digital value (the output value) is found to have overflowed with respect to at least one of the red light emitting diode, the green light emitting diode, and the blue light emitting diode, there is no need of obtaining the digital value (the output value) of the initial operation again such that no overflow occurs. This helps reduce the time for correcting the color of the illuminating light (time for performing the initial operation) compared with a case where the output value of the initial operation is obtained again such that no overflow occurs.

Incidentally, in the case in which the output value at the initial operation is obtained again such that no overflow occurs, it is necessary to reduce the value of the current supplied to each of the light emitting diodes. This requires provision of a new component for reducing the value of the current supplied to each of the light emitting diodes. With the above-described illuminating apparatus, as described above, there is no need of obtaining the output value of the initial operation such that no overflow occurs, and thus, in contrast to the case where the output value of the initial operation is obtained again, it is possible to reduce increase in number of components and in size of the illuminating apparatus.

In addition, a light emitting device a digital value (an output value) for which has overflowed receives a further smaller value of operation current, and thus generates further smaller amount of heat as it operates. As a result, a light emitting device a digital value (an output value) for which has overflowed is less liable to deteriorate compared with a light emitting device a digital value (an output value) for which has not overflowed. Thus, as described above, it is possible to satisfactorily reduce deterioration of the color of the illuminating light, without performing the color correction operation to a light emitting device a digital value (an output value) for which is found to have overflowed.

In the illuminating apparatus according to the first aspect described above, it is preferable that a value of a current supplied to each of the red light emitting diode, the green light emitting diode, and the blue light emitting diode in the color correction operation be equal to a value of a current supplied to each of the red light emitting diode, the green light emitting diode, and the blue light emitting diode in the initial operation. With this structure, deterioration rates of the red light emitting diode, the green light emitting diode, and the blue light emitting diode can be easily obtained.

In the illuminating apparatus according to the first aspect described above, it is preferable that the output portion include a light receiving device that receives light emitted from each of the red light emitting diode, the green light emitting diode, and the blue light emitting diode. With this structure, it is easy to receive the light emitted from each of the red light emitting diode, the green light emitting diode, and the blue light emitting diode.

In the illuminating apparatus according to the first aspect described above, the output portion may include an amplifier circuit portion that amplifies a value based on brightness of light emitted from each of the red light emitting diode, the green light emitting diode, and the blue light emitting diode.

In the illuminating apparatus according to the first aspect described above, the output portion may include an IV conversion portion that converts a value based on brightness of light emitted from each of the red light emitting diode, the green light emitting diode, and the blue light emitting diode, from a current value to a voltage value.

According to a second aspect of the present invention, a liquid crystal display device includes the illuminating apparatus structured as described above, and a liquid crystal display panel that is illuminated by the illuminating apparatus. With this structure, it is possible to obtain a liquid crystal display device capable of reducing time for correcting the color of the illuminating light.

### Advantages of the Invention

As hitherto described, the present invention makes it easy to obtain an illuminating apparatus capable of reducing the time for correcting the color of the illuminating light, and a liquid crystal display device provided therewith.

### BRIEF DESCRIPTION OF DRAWINGS

FIG. 1 An exploded perspective view of an illuminating apparatus according to an embodiment of the present invention;

FIG. 2 An enlarged plan view of a light output portion of the illuminating apparatus according to the embodiment shown in FIG. 1;

FIG. 3 A sectional view taken along line 100-100 in FIG. 2;

FIG. 4 A block diagram of a control system of the illuminating apparatus according to the embodiment shown in FIG. 1;

FIG. 5 A flow chart for illustrating the initial setting operation of an illuminating apparatus according to an embodiment of the present invention;

FIG. 6 A flow chart for illustrating a color correction operation of an illuminating apparatus according to an embodiment of the present invention; and

FIG. 7 A graph for illustrating deterioration rates of LEDs.

### BEST MODE FOR CARRYING OUT THE INVENTION

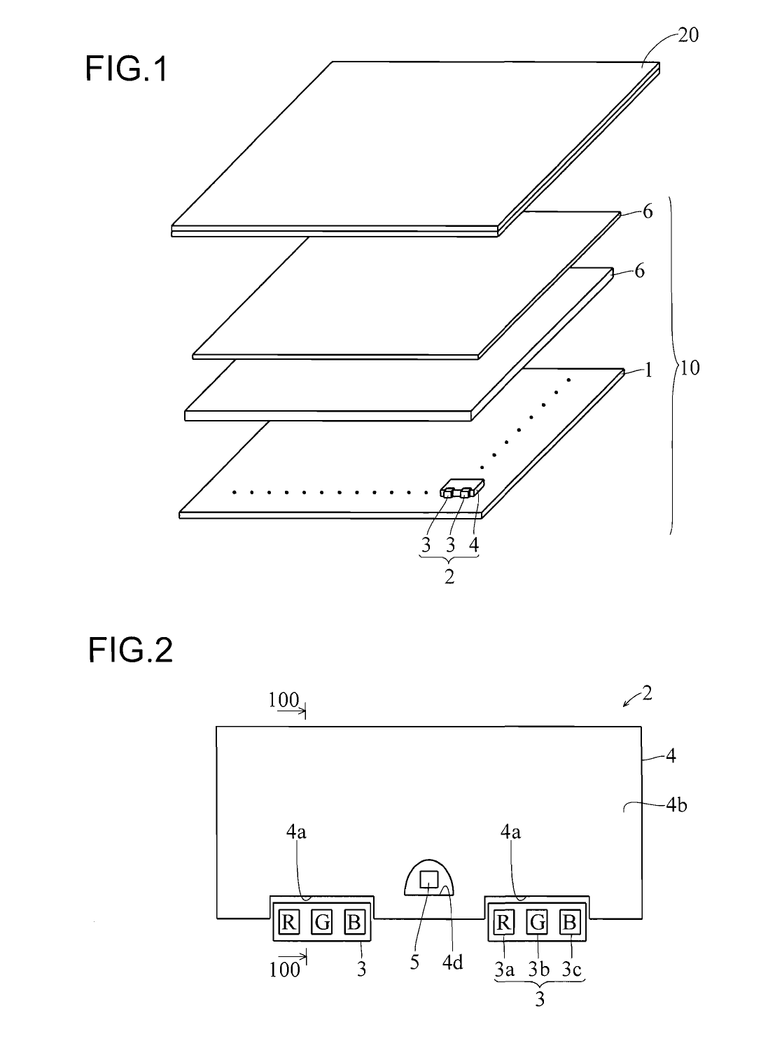

Hereinafter, with reference to FIGS. 1 to 4, a description will be given of the overall structure of an illuminating apparatus 10 of the present embodiment.

As shown in FIG. 1, the illuminating apparatus 10 of the present embodiment is used as a backlight unit that illuminates a liquid crystal display panel (a target to be illuminated) 20 of a liquid crystal display device, and is structured to output planar white light as illuminating light. When the illuminating apparatus 10 of the present embodiment is used as a backlight unit, it is placed at a rear surface side of the liquid crystal display panel 20 that is opposite from the display surface side of the liquid crystal display panel 20.

The illuminating apparatus 10 of the present embodiment is one that adopts a tandem method, and is provided with a plurality of light output portions 2 (each including a light emitting device 3 and a light guide plate 4) that are arranged in a matrix state. Each of the plurality of light output portions 2 generates white light that is to be outputted as illuminating light, and outputs the generated white light in a direction toward the liquid crystal display panel 20.

The plurality of light output portions 2 are each formed with the light emitting device 3 and the light guide plate 4 as described in FIG. 2. As the light emitting device 3 which is a component of each of the light output portions 2, two light emitting devices 3 are provided in each of the light output portions 2. Each of the light emitting devices 3 includes a red LED (a red light emitting diode) 3a that emits red light, a green LED (a green light emitting diode) 3b that emits green light, and a blue LED (a blue light emitting diode) 3c that emits blue light, and has a structure such that the three LEDs are provided in a package. Here, white light is obtained by mixing the three kinds of LED light (the red light, the green light, and the blue light) emitted from the red LED 3a, the green LED 3b, and the blue LED 3c. Specifically, values of operation currents supplied to the red LED 3a, the green LED 3b, and the blue LED 3c are individually controlled to adjust the brightness ratio of the three kinds of LED light to an appropriate value such that the mixing of the three kinds of LED light results in preferable white light. Incidentally, the red LED 3 a, the green LED 3b, and the blue LED 3c are capable of being controlled to emit light independently of one another in an initial setting operation (an initial operation) or in a color correction operation, which will be described later.

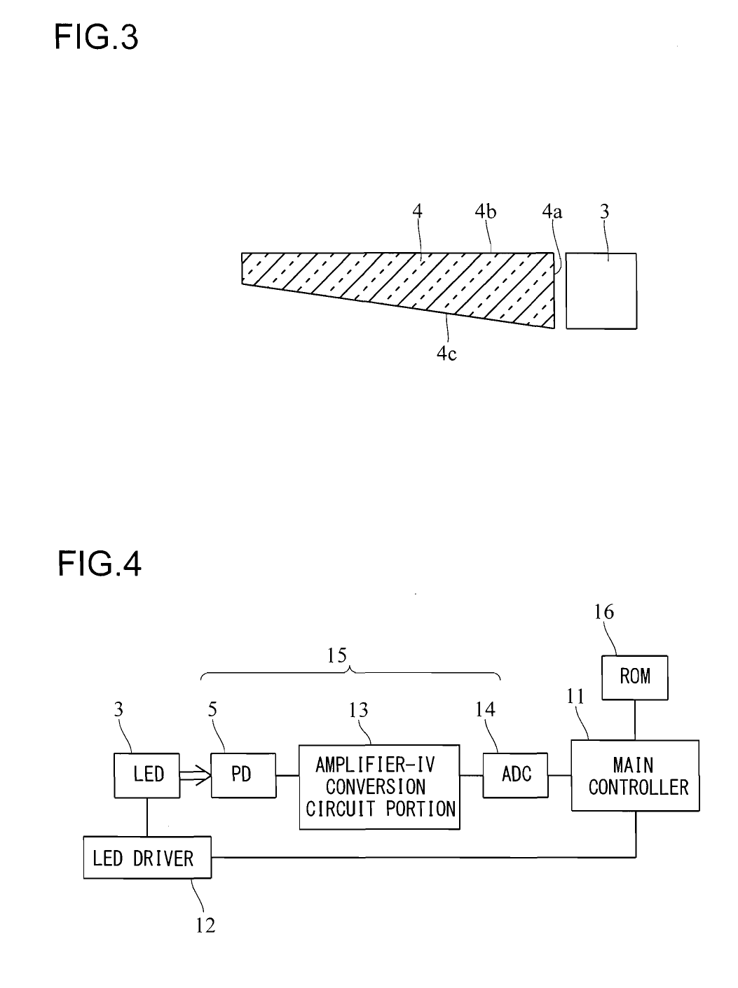

As shown in FIGS. 2 and 3, the light guide plate 4, which is another component of each of the light output portions 2, is provided one in each of the light output portions 2, for the purpose of guiding light emitted from the light emitting devices 3 in a direction toward the liquid crystal display panel 20 (see FIG. 1). That is, in each of the light output portions 2, light emitted from the two light emitting devices 3 is guided by one light guide plate 4.

The light guide plate 4 has at least a light entrance surface 4a facing a light emitting surface of the light emitting device 3, a light exit surface 4b that is a surface (a surface facing the liquid crystal display panel 20) perpendicular to the light entrance surface 4a, and a rear surface 4c (see FIG. 3) that is located opposite from the light exit surface 4b. Furthermore, the rear surface 4c is inclined to form the light guide plate 4 in a wedge shape that is gradually thinner farther away from the light entrance surface 4a. Moreover, as shown in FIG. 2, in a predetermined portion of the light guide plate 4, a through hole 4d is formed to penetrate the light guide plate 4 in the plate thickness direction.

In each of the plurality of light output portions 2, one photodiode (a light receiving device) 5 is provided to be inserted into the through hole 4d of the light guide plate 4. The photodiode 5 is placed substantially the same distance away from the two light emitting devices 3. The photodiode 5 receives the three kinds of LED light guided through the light guide plate 4, and outputs a current value (a current signal) corresponding to the brightness of the received light. Incidentally, the current value (the current signal) outputted from the photodiode 5 is used in the initial setting operation or the color correction operation, which will be described later.

In addition, as shown in FIG. 1, above the plurality of light output portions 2 (at the liquid crystal display panel 20 side), there is provided an optical sheet 6 into which the light from the light output portions 2 enters. The optical sheet 6, for example, diffuses or collects the light coming from the light output portions 2.

The red LED 3a, the green LED 3b, and the blue LED 3c provided to generate white light as illuminating light deteriorate at different deterioration speeds, and differences among their deterioration rates gradually increase with time of use. And, if the deterioration rate of one of the red LED 3a, the green LED 3b, and the blue LED 3c is larger than the deterioration rates of the other two, the brightness ratio of the three kinds of LED light is much different from the initial appropriate value of the brightness ratio. As a result, the illuminating light is not outputted as white light having a favorable color. To prevent this inconvenience, the illuminating apparatus 10 of the present embodiment is provided with a control system (see FIG. 4) that is capable of restoring a deteriorated color of the illuminating light to its initial state.

In the control system provided in the illuminating apparatus 10 of the present embodiment, as shown in FIG. 4, an LED driver 12 is connected to a main controller 11, and the current supplied to the light emitting device (LED) 3 is controlled by the main controller 11. The main controller 11 is an example of the “control portion” of the present invention.

The control system further includes, for example, an amplifier-IV conversion circuit portion 13 that amplifies a current value (a current signal) outputted from a photodiode (PD) 5 and converts the amplified current value (the current signal) into a voltage value (a voltage signal), and an A/D converter (ADC) 14 that coverts the voltage value (the voltage signal) fed from the amplifier-IV conversion circuit portion 13, from an analog value to a digital value. Incidentally, the amplifier-IV conversion circuit portion 13 is an example of the “amplifier circuit portion” and the “IV conversion portion” of the present invention, and the A/D converter 14 is an example of the “AD conversion portion” of the present invention.

And, via the amplifier-IV conversion circuit portion 13 and the A/D converter 14, the photodiode (PD) 5 is connected to the main controller 11. That is, the main controller 11 receives, via the amplifier-IV conversion circuit portion 13 and the A/D converter 14, a voltage value (an output value) corresponding to a current value outputted from the photodiode 5. Thus, according to the present embodiment, the photodiode (PD) 5, the amplifier-IV conversion circuit portion 13, and the A/D converter (ADC) 14 constitute an output portion 15 that receives light emitted from the light emitting device 3 and outputs a value (an output value) corresponding to the brightness of the received light.

Furthermore, a memory (ROM) 16 is connected to the main controller 11. Stored in this memory (ROM) 16 are an initial value of the value (the output value) corresponding to the brightness of LED light in a state in which the illuminating light has a preferable white color, an initial value of the value of an operation current supplied to the light emitting device 3, and the like.

Here, in the illuminating apparatus 10 of the present embodiment, the initial setting operation and the color correction operation are performed to correct the color of the illuminating light. The initial setting operation is performed, for example, when the illuminating apparatus 10 is produced, and the color correction operation is performed, for example, when the color of the illuminating light is deteriorated after it is used for a long time. The initial setting operation and the color correction operation are both controlled by the main controller 11.

Specifically, the main controller 11 is structured such that, in the initial setting operation, the main controller 11 supplies a current of a predetermined value to each of the red LED 3a, the green LED 3b, and the blue LED 3c one by one in turn.

Furthermore, according to the present embodiment, the main controller 11 judges whether or not the initial value of the value (the output value) corresponding to the brightness of the light emitted from each of the LEDs has overflowed, and also stores the initial value of the output value in the memory 16.

In addition, the main controller 11 is structured such that it performs the color correction operation to a light emitting device 3 with respect to which the output values for all the red LED 3a, the green LED 3b, and the blue LED 3c are judged not to have overflowed. On the other hand, the main controller 11 does not perform the color correction operation to a light emitting device 3 with respect to which the initial value for at least one of the red LED 3a, the green LED 3b, and the blue LED 3c is judged to have overflowed.

In addition, the main controller 11 is structured such that, when the mode is switched from the normal mode to the correction mode for the main controller 11 to perform the color correction operation, the main controller 11 obtains the deterioration rate of each of the red LED 3a, the green LED 3b, and the blue LED 3c from the output value of the output portion 15. The main controller 11 is also structured such that, based on the deterioration rate, it adjusts the value of the operation current to be supplied to each of the LEDs. Incidentally, the deterioration rate of each of the red LED 3a, the green LED 3b, and the blue LED 3c is obtained through comparison with the initial value stored in the memory 16. Through this method of control, it is possible to restore the brightness ratio of the three kinds of LED light to the initial state, which results in illuminating light having a preferable color.

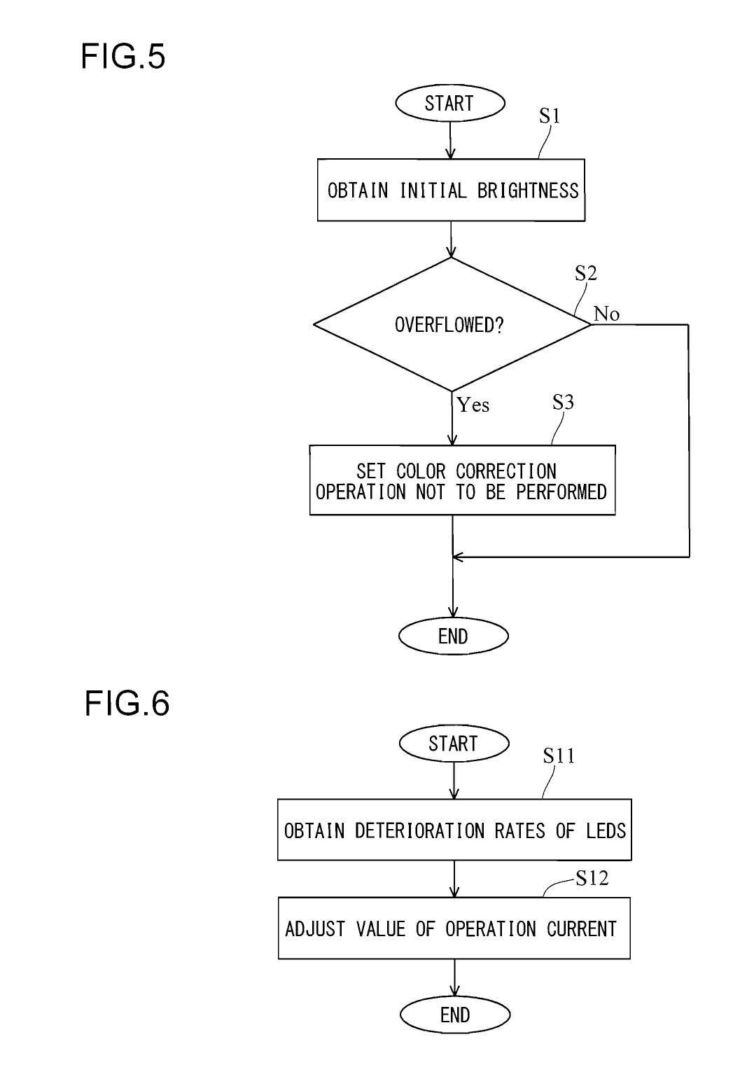

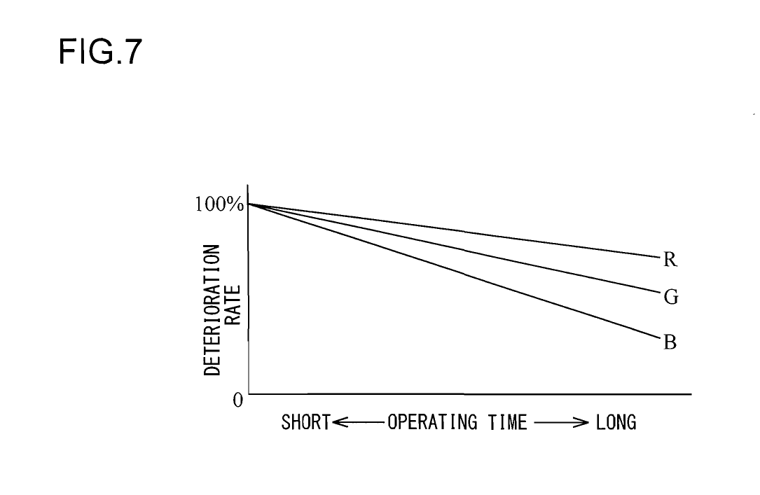

Hereinafter, with reference to FIGS. 5 and 6, a description will be given of how the color correction operation is performed in the illuminating apparatus 10 of the present embodiment.

First, in the initial setting operation, as shown in FIG. 5, in step S 1, initial values of brightness (initial brightness) of the red LED 3a, the green LED 3b, and the blue LED 3c are obtained with respect to all the light emitting devices 3.

Specifically, the main controller 11 supplies a current of a predetermined value (for example, 40 mA) to each of the red LED 3a, the green LED 3b, and the blue LED 3c, one by one in turn. As a result, the LEDs emit light one by one in turn. At this time, light emitted from each of the red LED 3a, the green LED 3b, and the blue LED 3c is received by the photodiode 5, and a current value (a current signal) based on the brightness of the light received from each of the red LED 3a, the green LED 3b, and the blue LED 3c is outputted from the photodiode 5.

Then, the current values (the current signals) outputted from the photodiode 5 are each amplified and converted to a voltage value (a voltage signal) by the amplifier-IV conversion circuit portion 13.

Thereafter, the voltage value (the voltage signal) is converted by the A/D converter 14, from an analog value to a digital value, in the range of, for example, 0 to 255 (8 bits).

There is a large variation in light emitting efficiency (light emitting characteristic) among the LEDs, and the variation may sometimes cause a case in which the initial brightness of light emitted from each of the LEDs is higher than expected. In such a case, the converted digital value (the output value) corresponding to the brightness of the light overflows and is converted to “255”. If the digital value (the output value) overflows as described above, the initial value of the brightness of each of the red LED 3a, the green LED 3b, and the blue LED 3c cannot be obtained, and this makes it impossible to correct the brightness ratio to an appropriate value in the color correction operation, which is performed later.

Next, in step S2, the main controller 11 judges whether or not the digital value (the output value of the output portion 15) has overflowed.

Specifically, the main controller 11 judges, with respect to all of the light emitting devices 3, whether or not the digital values (the output values) for the red LED 3a, the green LED 3b, and the blue LED 3c have overflowed (that is, whether or not the digital values are “equal to 255 (or, equal to 255 or larger)”).

If at least one of the digital values (the output values) for the red LED 3a, the green LED 3b, and the blue LED 3c of a light emitting device 3 is found to have overflowed (“equal to 255 (or, equal to 255 or larger)”), then in step S3, it is set that the value of the operation current supplied to the light emitting device 3 is not to be corrected in the color correction operation, which is performed later.

On the other hand, if the digital values (the output values) for the red LED 3a, the green LED 3b, and the blue LED 3c of a light emitting device 3 are all found not to have overflowed (“0 to 254 (smaller than 255)”), then the initial value of the digital value (the output value) for each of the LEDs of the light emitting device 3 is stored in the memory 16.

Next, in the color correction operation, as shown in FIG. 6, brightness of each of the red LED 3a, the green LED 3b, and the blue LED 3c is obtained in step S11.

Specifically, the main controller 11 supplies the red LED 3a, the green LED 3b, and the blue LED 3c, one by one in turn, a current of a value (for example, 40 mA) that is the same as the value of the current supplied to each of the red LED 3a, the green LED 3b, and the blue LED 3c in the initial setting operation. As a result, light emitted from each of the red LED 3a, the green LED 3b, and the blue LED 3c is received by the photodiode 5, and a current value (a current signal) based on the brightness of the light received from each the red LED 3a, the green LED 3b, and the blue LED 3c is outputted from the photodiode 5.

Then, the current value (the current signal) outputted from the photodiode 5 is amplified and converted to a voltage value (a voltage signal) by the amplifier-IV conversion circuit portion 13.

Thereafter, the voltage value (the voltage signal) is converted by the A/D converter 14, from an analog value to a digital value.

Then, the main controller 11 compares the above-obtained digital value (the output value) with the initial value of the digital value (the output value) stored in the memory 16 at the time of the initial setting operation, to obtain the deterioration rate of each of the red LED 3a, the green LED 3b, and the blue LED 3c.

Thereafter, in step S12, based on the deterioration rate of each of the red LED 3a, the green LED 3b, and the blue LED 3c, the value of the operation current supplied to each of the LEDs is adjusted. The adjustment of the value of the operation current is controlled by the main controller 11, and current supply to each of the red LED 3a, the green LED 3b, and the blue LED 3c is performed by the LED driver 12.

The value of the operation current is adjusted in the following manner. First, one of the red LED 3a, the green LED 3b, and the blue LED 3c that has the largest deterioration rate is identified. Then, control is performed such that the value of the operation current supplied to the LED having the largest deterioration rate is fixed, while the values of the operation currents supplied to the other LEDs are reduced. That is, in a state in which the brightness of the LED having the largest deterioration rate is fixed, the brightness of the other LEDs is adjusted, to thereby restore the brightness ratio of the three kinds of LED light to its initial state. As a result, the color of the illuminating light obtained by mixing the three kinds of LED light is corrected to its initial state.

According to the present embodiment, as described above, the main controller 11 judges, with respect to each of the red LED 3a, the green LED 3b, and the blue LED 3c, whether or not the output value at the initial setting operation has overflowed. As the output value of a light emitting device 3 in response to a current supplied thereto increases (that is, as the light emitting efficiency of the light emitting device 3 increases), the value of the operation current supplied to the light emitting device 3 in its operation decreases, and thus the amount of heat generated in its operation is reduced. Thus, a light emitting device 3 the output value for which has overflowed is less likely to deteriorate after a long time of use, compared with a light emitting device 3 an output value for which has not overflowed. That is, a light emitting device 3 an output value for which is large is less liable to deteriorate the color of the illuminating light, which results in less need of the color correction operation. Thus, even with the above-described structure in which the main controller 11 does not perform the color correction operation to a light emitting device 3 with respect to which the output value for at least one of the red LED 3a, the green LED 3b, and the blue LED 3c is found to have overflowed, it is possible to reduce the deterioration of the color of the illuminating light. Moreover, since the color correction operation is performed less frequently, the length of time taken for the color correction operation can accordingly be reduced.

In addition, since the color correction operation is not performed to a light emitting device 3 with respect to which the output value for at least one of the red LED 3a, the green LED 3b, and the blue LED 3c is judged to have overflowed, there is no need of obtaining the output value at the initial setting operation again such that no overflow occurs. This helps reduce the time for correcting the color of the illuminating light (time for performing the initial setting operation), compared with a case in which the output value at the time of the initial setting operation is obtained again such that no overflow occurs.

Incidentally, in the case in which the output value at the time of the initial setting operation is obtained again such that no overflow occurs, it is necessary to reduce the value of the current supplied to each of the LEDs. This requires provision of a new component for reducing the value of the current supplied to each of the LEDs. With the illuminating apparatus 10 of the present embodiment, as described above, there is no need of obtaining the output value at the time of the initial setting operation again such that no overflow occurs, and thus, in contrast to the case in which the output value at the initial setting operation is obtained again, it is possible to reduce the increase in number of components and in size of the illuminating apparatus 10.

In addition, according to the present embodiment, as described above, by adjusting the value of the current supplied to each of the red LED 3a, the green LED 3b, and the blue LED 3c in the color correction operation equal to the value of the current (for example, 40 mA) supplied to each of the red LED 3a, the green LED 3b, and the blue LED 3c in the initial setting operation, the deterioration rates of the red LED 3a, the green LED 3b, and the blue LED 3c can be obtained easily.

The embodiments disclosed herein are to be considered in all respects as illustrative and not restrictive. The scope of the present invention is set out in the appended claims and not in the description of the embodiments hereinabove, and includes any variations and modifications within the sense and scope equivalent to those of the claims.

For example, the embodiments described hereinbefore deal with an example in which the present invention is applied to an illuminating apparatus that adopts a tandem method, but this is not meant as a limitation, and the present invention may be applied to an illuminating apparatus that adopts any method other than the tandem method.

Also, the above embodiments deal with an example in which the illuminating apparatus is used in a liquid crystal display device, but this is not meant to limit the present invention, and the illuminating apparatus may be used in devices other than the liquid crystal display device.

Also, the above-described embodiments deal with a case in which whether or not an output value for each light emitting device has overflowed (that is, whether or not the output value is “equal to 255 (or, equal to 255 or larger)”), and the color correction operation is not performed to a light emitting device an output value for which has overflowed, but this is not meant to limit the present invention, and alternatively, the following may be adopted. That is, it is judged whether or not an output value for each light emitting device is equal to a predetermined value (for example, “200”) or larger, and the color correction operation is not performed to a light emitting device an output value for which is equal to the predetermined value or larger. A light emitting device an output value for which is equal to “200” or larger is less likely to deteriorate after a long time of use, and thus, by not performing the color correction operation to such a light emitting device, it is possible to further reduce the time for the color correction operation, while reducing deterioration of the color of the illuminating light.

Also, the above-described embodiments deal with a case in which the judgment of whether or not an output value for each light emitting device has overflowed is performed when the initial setting operation is performed, but this is not meant to limit the present invention, and alternatively, the following may be adopted. That is, an initial value of brightness is obtained when the initial setting operation is performed, and the judgment of whether or not an output value for each light emitting device has overflowed is performed when the color correction operation is performed.

Also, the above-described embodiments deal with a case in which, when the color correction operation is performed, in the state in which the brightness of the LED having the largest deterioration rate is fixed, the brightness of the other LEDs is adjusted, but this is not meant to limit the present invention, and alternatively, the following may be adopted. That is, in a state in which the brightness of the LED having the second largest deterioration rate is fixed, the brightness of the other LEDs is adjusted, or instead, in a state in which the brightness of the LED having the smallest deterioration rate is fixed, the brightness of the other LEDs is adjusted.

In the embodiments described hereinbefore deal with an example in which one light receiving device is provided for every two light emitting devices, but this is not meant to limit the present invention, and one light receiving device may be provided for every three or more light emitting devices, or one light receiving device may be provided for each light emitting device.

### LIST OF REFERENCE SYMBOLS

3 light emitting device

3a red LED (red light emitting diode)

3b green LED (green light emitting diode)

3c blue LED (blue light emitting diode)

5 photodiode (light receiving device)

10 illuminating apparatus

11 main controller (control portion)

13 amplifier-IV conversion circuit portion (amplifier circuit portion, IV conversion portion)

14 A/D converter (AD conversion portion)

15 output portion

20 liquid crystal display panel (target to be illuminated)

1. An illuminating apparatus that generates illuminating light by mixing red light, green light, and blue light, and that illuminates a target to be illuminated with the illuminating light, the illuminating apparatus comprising:
a plurality of light emitting devices each including a red light emitting diode that emits red light, a green light emitting diode that emits green light, and a blue light emitting diode that emits blue light;
an output portion that receives light emitted from each of the red light emitting diode, the green light emitting diode, and the blue light emitting diode, and that outputs a value corresponding to brightness of received light; and
a control portion that obtains a deterioration rate of each of the red light emitting diode, the green light emitting diode, and the blue light emitting diode from an output value of the output portion, and that performs a color correction operation of correcting a color of the illuminating light by adjusting, based on the deterioration rate, a value of an operation current supplied to each of the red light emitting diode, the green light emitting diode, and the blue light emitting diode,
wherein
the control portion performs, with respect to each of the red light emitting diode, the green light emitting diode, and the blue light emitting diode, judgment of whether or not the output value at an initial operation before the color correction operation is performed is equal to or larger than a predetermined value, the control portion performing the color correction operation to a light emitting device of the light emitting devices with respect to which the output value is judged to be smaller than the predetermined value with respect to all the red light emitting diode, the green light emitting diode, and the blue light emitting diode, and the control portion not performing the color correction operation to a light emitting device of the light emitting devices with respect to which the output value is judged to be equal to or larger than the predetermined value with respect to at least one of the red light emitting diode, the green light emitting diode, and the blue light emitting diode.

2. The illuminating apparatus of claim 1,
wherein
the output portion includes an AD conversion portion that converts a value based on brightness of light emitted from each of the red light emitting diode, the green light emitting diode, and the blue light emitting diode, from an analog value to a digital value, and that feeds the digital value to the control portion, and
the control portion judges, with respect to each of the red light emitting diode, the green light emitting diode, and the blue light emitting diode, whether or not the digital value at the initial operation has overflowed, the control portion performing the color correction operation to a light emitting device of the light emitting devices with respect to which the digital value is judged, with respect to all the red light emitting diode, the green light emitting diode, and the blue light emitting diode, not to have overflowed, and the control portion not performing the color correction operation to a light emitting device of the light emitting devices with respect to which the digital value is judged to have overflowed with respect to at least one of the red light emitting diode, the green light emitting diode, and the blue light emitting diode.

3. The illuminating apparatus of claim 1,
wherein
a value of a current supplied to each of the red light emitting diode, the green light emitting diode, and the blue light emitting diode in the color correction operation is equal to a value of a current supplied to each of the red light emitting diode, the green light emitting diode, and the blue light emitting diode in the initial operation.

4. The illuminating apparatus of claim 1,
wherein
the output portion includes a light receiving device that receives light emitted from each of the red light emitting diode, the green light emitting diode, and the blue light emitting diode.

5. The illuminating apparatus of claim 1,
wherein
the output portion includes an amplifier circuit portion that amplifies a value based on brightness of light emitted from each of the red light emitting diode, the green light emitting diode, and the blue light emitting diode.

6. The illuminating apparatus of claim 1,
wherein
the output portion includes an IV conversion portion that converts a value based on brightness of light emitted from each of the red light emitting diode, the green light emitting diode, and the blue light emitting diode, from a current value to a voltage value.

7. A liquid crystal display device, comprising:
the illuminating apparatus of claim 1; and
a liquid crystal display panel that is illuminated by the illuminating apparatus.

8. A liquid crystal display device, comprising:
the illuminating apparatus of claim 2; and
a liquid crystal display panel that is illuminated by the illuminating apparatus.

9. A liquid crystal display device, comprising:
the illuminating apparatus of claim 3; and
a liquid crystal display panel that is illuminated by the illuminating apparatus.

10. A liquid crystal display device, comprising:
the illuminating apparatus of claim 4; and
a liquid crystal display panel that is illuminated by the illuminating apparatus.

11. A liquid crystal display device, comprising:
the illuminating apparatus of claim 5; and
a liquid crystal display panel that is illuminated by the illuminating apparatus.

12. A liquid crystal display device, comprising:
the illuminating apparatus of claim 6; and
a liquid crystal display panel that is illuminated by the illuminating apparatus.
